(19) United States
(12) Patent Application Publication
(10) Pub. No.: US 2023/0403415 A1
(43) Pub. Date: Dec. 14, 2023

(54) Adaptive Decoder-Driven Encoder Reconfiguration

(71) Applicants: Advanced Micro Devices, Inc, Santa Clara, CA (US); ATI Technologies ULC, Markham (CA)

(72) Inventors: Ihab Amer, Stouffville (CA); Gabor Sines, Toronto (CA); Haibo Liu, North York (CA); Khaled Mammou, Danville, CA (US); Arun Sundaresan Iyer, Bangalore (IN)

(21) Appl. No.: 17/838,552

(22) Filed: Jun. 13, 2022

(51) Int. Cl. H04N 21/2343; H04N 21/4402; H04N 21/442

(52) U.S. Cl. CPC H04N 21/2343; H04N 21/4402; H04N 21/44209

(57) ABSTRACT

Adaptive decoder-drive encoder reconfiguration techniques are described. In one example, techniques include detecting an operational condition at a consumer using a sensor, the consumer receiving a communication of digital content from an encoder; generating an adaptation instruction by the decoder based on the detecting; transmitting the adaptation instruction by the decoder for receipt by the encoder; and receiving an adapted communication of the digital content generated by the encoder, the adapted communication caused by reconfiguration of the encoder based on the adaptation instruction received from the decoder.

### BACKGROUND

A variety of types of digital content are communicated between entities in a variety of scenarios. A producer, for instance, includes an encoder that encodes the digital content for receipt by a consumer. The consumer then employs a decoder to decode the digital content for output, e.g., for rendering. The encoder, as part of encoding the digital content, utilizes techniques including compression, encryption, and digital rights management. Accordingly, the decoder is also tasked with decoding the digital content using corresponding techniques. In this scenario, therefore, operations of the decoder in processing the digital content are dictated by encoding used by the encoder.

### BRIEF DESCRIPTION OF THE DRAWINGS

The detailed description is described with reference to the accompanying figures.

FIG. 1 is a block diagram of a non-limiting example system having a communication link between a producer of a transmission of digital content that employs an encoder and a consumer of the transmission of the digital content that employs a decoder.

FIG. 2 depicts a non-limiting example showing operation of the decoder and encoder of FIG. 1 in greater detail.

FIG. 3 depicts a non-limiting example in which a sensor of the consumer is a memory sensor that detects an operational condition involving memory and generates an adaptation instruction to restrict reference frames for communication to the encoder of the producer.

FIG. 4 depicts a non-limiting example in which a sensor of the consumer is a battery sensor or temperature sensor that detects an operational condition and generates an adaptation instruction to manipulate a bitstream for communication to the encoder of the producer.

FIG. 5 depicts a non-limiting example in which a sensor of the consumer is incorporated as part of the decoder that detects an operational condition of the decoder involving latency and generates an adaptation instruction to manipulate an encoder rate for communication to the encoder of the producer.

FIG. 6 depicts a non-limiting example in which a sensor of the consumer is incorporated as part of the decoder and detects an operational condition of the decoder involving corruption and generates an adaptation instruction including a frame instruction for communication to the encoder of the producer.

FIG. 7 depicts a non-limiting example in which a sensor of the consumer is incorporated as part of the decoder and detects an operational condition of the decoder involving quality and generates an adaptation instruction involving quality for communication to the encoder of the producer.

FIG. 8 depicts a procedure in an example implementation of adaptive decoder-driven encoder reconfiguration.

### DETAILED DESCRIPTION

### Overview

Communication of digital content involves a producer which is an entity (e.g., apparatus) that transmits a communication of the digital content and a consumer which is an entity that receives the communication, e.g., for rendering. Digital content is configurable in a variety of ways, including digital video, digital audio, digital media, digital documents, and so forth.

In a conventional digital video example, the encoder generates the communication as a bitstream based on frames of the digital video that are transmitted to the decoder. The encoder is tasked with determining “how” the digital video is encoded, e.g., particular encryption, compression, and/or digital rights management techniques used and the parameters of those techniques. The encoder, for instance, is tasked in conventional techniques in determining how to adapt to runtime constraints such as available network bandwidth, system stability of the producer, computational capacity of the producer, and so forth. Thus, the encoder has “control of its own destiny,” such as to favor one aspect over another based on the encoder, itself. In one such example, the encoder favors a reduction in power usage over quality in the digital video being transmitted in order to save power on the producer side in a scenario in which an amount of power from a battery of the producer is limited.

In conventional techniques, however, this functionality is not available to a consumer and corresponding decoder that is to receive the communication from the encoder of the producer. Rather, the decoder in conventional techniques is limited to behaviors dictated by the communication it receives from the encoder. The decoder, for instance, is limited to use of decompression, decryption, and digital rights management techniques that correspond to the techniques used by the encoder to encode the communication of the digital content. Likewise, the decoder is also limited to the quality of the communication made available by the encoder. As such, the decoder does not have control, under conventional techniques, as to what is received from the encoder but rather has to follow the “recipe” specified by the encoder.

To solve these problems, adaptive decoder-driven encoder reconfiguration techniques are described. As part of this, a feedback channel is provided from the decoder to the encoder. This allows the decoder to adapt to runtime constraints by dictating adaptation instructions to the encoder for actions to reconfigure the encoder to respond to conditions at the decoder, which is not possible under conventional techniques. As a result, communication between the encoder and decoder is improved with a corresponding increase in operational efficiency in devices that implement these techniques.

During runtime, for instance, the decoder is configured to adapt to changing conditions encountered at the consumer. To do so, a sensor is leveraged to detect an operational condition at the consumer. Based on the detected operational condition by the sensor, the decoder utilizes an instruction generator to generate a corresponding adaptation instruction. The encoder, upon receipt of the adaptation instruction, reconfigures itself to generate adapted communications of subsequent portions of the digital content to the consumer, e.g., dynamically during runtime and communication of the digital content between the entities. In this way, the decoder is given a degree of control over communications received by the decoder, which is not possible in conventional techniques. A variety of other instances are also contemplated, examples of which are described in the following discussion and shown using corresponding figures.

In some aspects, the techniques described herein relate to a method including: detecting an operational condition at a consumer using a sensor, the consumer receiving a communication of digital content from an encoder; generating an adaptation instruction by the decoder based on the detecting; transmitting the adaptation instruction by the decoder for receipt by the encoder; and receiving an adapted communication of the digital content generated by the encoder, the adapted communication caused by reconfiguration of the encoder based on the adaptation instruction received from the decoder.

In some aspects, the techniques described herein relate to a method, wherein the adaptation instruction describes the operational condition, the adaptation instruction is implicit and configured to cause the encoder to determine an action to be performed for the reconfiguration of the encoder.

In some aspects, the techniques described herein relate to a method, wherein the adaptation is explicit and describes an action to be performed for the reconfiguration of the encoder.

In some aspects, the techniques described herein relate to a method, wherein the operational condition describes operation of hardware of the consumer.

In some aspects, the techniques described herein relate to a method, wherein the sensor is a memory sensor, the hardware is memory of the consumer.

In some aspects, the techniques described herein relate to a method, wherein the sensor is a battery sensor and the hardware is a battery.

In some aspects, the techniques described herein relate to a method, wherein the sensor is a temperature sensor.

In some aspects, the techniques described herein relate to a method, wherein the sensor describes operation of the decoder in receiving the digital content from the encoder.

In some aspects, the techniques described herein relate to a method, wherein the operation of the decoder describes transmission quality of the digital content from the encoder, corruption in communication of the digital content from the encoder, or latency in receipt of the digital content from the encoder.

In some aspects, the techniques described herein relate to a system including: a sensor to detect an operational condition of a consumer; and a decoder of the consumer to receive a communication of digital video from an encoder, the decoder including an instruction generator to generate an adaptation instruction for transmission to the encoder, the adaptation instruction generated based on the operational condition detected by the sensor and configured to cause reconfiguration of the encoder to generate an adapted communication of the digital video for receipt by the decoder.

In some aspects, the techniques described herein relate to a system, wherein the adaptation instruction is implicit and describes the operational condition and configured to cause the encoder to determine an action to be performed for the reconfiguration of the encoder.

In some aspects, the techniques described herein relate to a system, wherein the adaptation is explicit and describes an action to be performed for the reconfiguration of the encoder.

In some aspects, the techniques described herein relate to a system, wherein the operational condition describes operation of hardware of the consumer.

In some aspects, the techniques described herein relate to a system, wherein: the sensor is a memory sensor and the hardware is memory of the consumer; the sensor is a battery sensor and the hardware is a battery; or the sensor is a temperature sensor.

In some aspects, the techniques described herein relate to a system, wherein the sensor describes operation of the decoder in receiving the digital content from the encoder.

In some aspects, the techniques described herein relate to a system, wherein the operation of the decoder describes transmission quality of the digital content from the encoder, corruption in communication of the digital content from the encoder, or latency in receipt of the digital content from the encoder.

In some aspects, the techniques described herein relate to a method including: transmitting a communication of digital content by an encoder of a producer for receipt by a decoder of a consumer; receiving an adaptation instruction from the decoder of the consumer, the adaptation instruction based on an operational condition detected at the consumer using a sensor; adapting the encoder based on the adaptation instruction; generating an adapted communication using the adapted encoder; and transmitting the adapted communication for receipt by the decoder of the consumer.

In some aspects, the techniques described herein relate to a method, wherein the adaptation instruction is implicit and describes the operational condition and further including determining an action to be performed for the adapting of the encoder based on the adaptation instruction.

In some aspects, the techniques described herein relate to a method, wherein the adaptation is explicit and describes an action to be performed for the adapting of the encoder.

In some aspects, the techniques described herein relate to a method, wherein the operational condition describes operation of hardware of the consumer or operation of the decoder in receiving the digital content from the encoder.

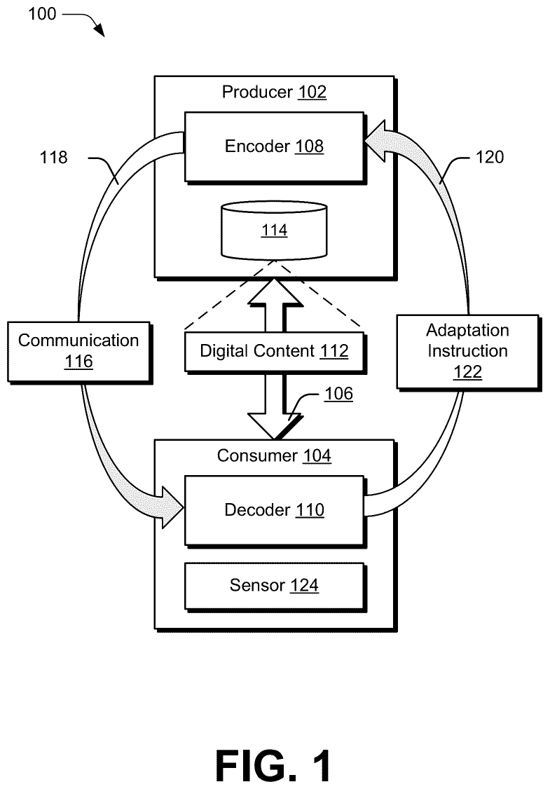

FIG. 1 is a block diagram of a non-limiting example system 100 configured to employ adaptive decoder-driven encoder reconfiguration. The system 100 includes a producer 102 and a consumer 104 that are communicatively coupled, one to another, using a communication link 106.

The producer 102 and the consumer 104 correspond to devices configured to interface with each other, e.g., using the communication link 106. Examples of those devices include, by way of example and not limitation, computing devices, servers, mobile devices (e.g., wearables, mobile phones, tablets, laptops), processors (e.g., graphics processing units, central processing units, and accelerators), digital signal processors, disk array controllers, hard disk drive host adapters, memory cards, solid-state drives, wireless communications hardware connections, Ethernet hardware connections, switches, bridges, network interface controllers, and other apparatus configurations. It is to be appreciated that in various implementations, the producer 102 and consumer 104 are configured as any one or more of those devices listed just above and/or a variety of other devices without departing from the spirit or scope of the described techniques.

The producer 102 includes an encoder 108 and the consumer 104 includes a decoder 110. The encoder 108 is configured to encode digital content 112, illustrated as stored in a storage device 114. Digital content 112 is configurable to take a variety of forms, examples of which include digital video, digital audio, digital media, digital documents, and so forth. Portions of the digital content 112, once encoded, are generated into respective communications 116 (e.g., as packets, files, etc.) for transmission via a transmission channel 118 to the consumer 104 via the communication link 106, e.g., using a wired or wireless connection.

The consumer 104 then employs a decoder 110 to decode the portion of the digital content 112 included in the communication 116 for output, e.g., for rendering. The encoder 108, as part of encoding the digital content 112, utilizes techniques including compression, encryption, and/or digital rights management. Accordingly, the decoder 110 is also tasked with decoding the digital content 112 using corresponding decompression, decryption, and/or digital rights management techniques. The encoder 108 and decoder 110, for instance, are configured to support a variety of video encoding formats (e.g., MP4), video codecs (H.264), audio formats (e.g., MP3, Dolby® Atmos), digital rights management (e.g., Google® WideVine, Microsoft® PlayReady, Adobe® Flash Access, Apple® Fairplay), adaptive bitrate video formats, and so forth.

In accordance with the described techniques, the producer 102 and the consumer 104 communicate over the communication link 106, which is illustrated as bi-directional. The communication link 106 includes a transmission channel 118 from the encoder 108 to the decoder 110 and a feedback channel 120 from the decoder 110 back to the encoder 108.

The feedback channel 120 supports communication of an adaptation instruction 122 generated to address operational conditions at the consumer 104, which is not possible using conventional techniques. Conventional techniques, for instance, are implemented such that an encoder adapts to runtime constraints, but the decoder is limited to receipt of communications without input. In the techniques described herein, however, the feedback channel 120 supports communication of an adaptation instruction 122 generated by the decoder 110. The adaptation instruction 122 is generated by the decoder 110 based on operational conditions detected by a sensor 124 at the consumer 104. This permits the encoder 108 to react to operational conditions at the consumer 104 and support a degree of control of what is received by the consumer 104 from the encoder 108.

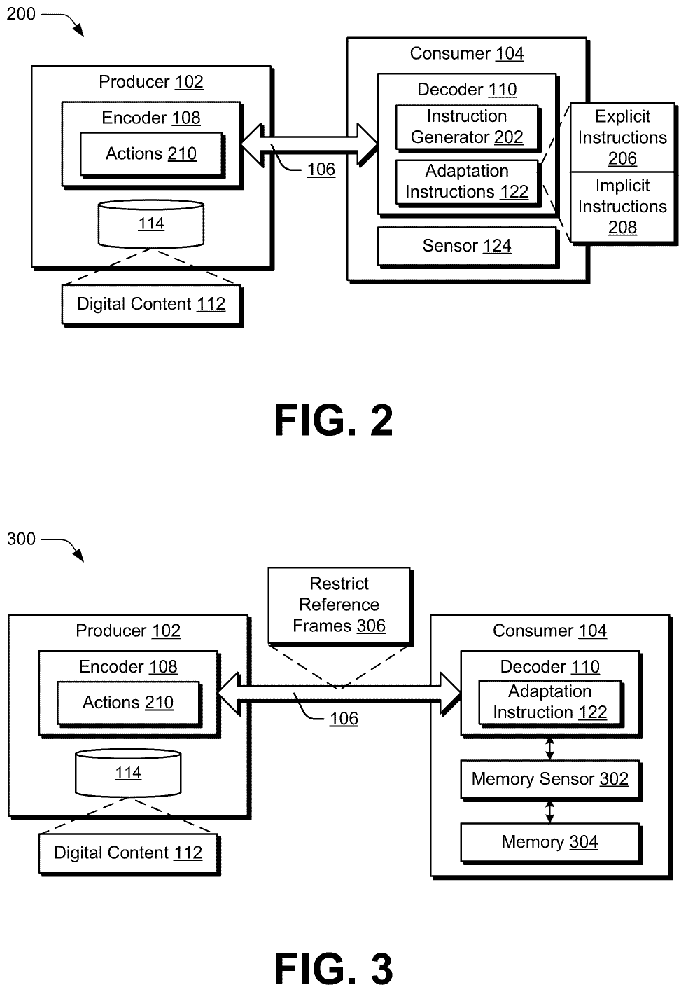

FIG. 2 depicts a non-limiting example 200 showing operation of the encoder 108 and decoder 110 of FIG. 1 in greater detail. As before, the producer 102 and the consumer 104 are communicatively coupled via a communication link 106. An encoder 108 encodes portions of the digital content 112, thereby forming communications that are received by the consumer 104, e.g., as a bitstream. The consumer 104 then employs a decoder 110 to decode the communications for rendering and display, e.g., as frames of a digital video.

The consumer 104 includes a sensor 124 that is configured to detect operational conditions at the consumer 104. The operational conditions are configurable in a variety of ways to describe operation of the consumer 104. As such, the sensor 124 is also configurable in a variety of ways to detect those operational conditions.

In a first example, the sensor 124 is configured as a dedicated hardware sensor that detects operational conditions of hardware components associated with the consumer 104, e.g., in receiving the communication from the producer 102. The sensor 124, for instance, is configurable to detect temperature, environmental conditions (e.g., light, smoke), power usage, battery level, location, motion (e.g., accelerometer), communication bandwidth, signal interference, signal strength, and so forth. In a second example, the sensor 124 is configured to detect operational conditions of the decoder 110 involving data communication to and from the decoder 110. The sensor 124, for instance, is configurable as part of the decoder to detect bandwidth, latency, quality, and/or corruption of communications received by the decoder 110. A variety of other examples are also contemplated.

The decoder 110 includes an instruction generator 202 that is configured to generate adaptation instructions 122 based on the operational conditions detected by the sensor 124. The adaptation instructions 122 are configurable as explicit instructions 206 or implicit instruction 208. As previously described, explicit instructions 206 reference an action 210 that is to be performed by the encoder 108. The instruction generator 202, for instance, receives an input from the sensor 124 indicating that operation of the consumer 104 is thermally unsustainable. Therefore, an explicit instruction 206 references a particular action 210 that is to be performed by the encoder 108 to address this, e.g., reduce bandwidth. The explicit instruction 206 is configured to describe the action 210 as a particular command, operation, key, and so forth. In this way, explicit instructions 206 give a measure of direct control over the encoder 108 by the decoder 110 and thus corresponding control of communications received by the decoder 110 from the encoder 108.

Implicit instructions 208, on the other hand, are a type of adaptation instruction 122 that is processed by the encoder 108 to determine which actions 210 are to be performed to address operational conditions detected by the sensor 124 of the consumer 104. Thus, in this example the implicit instruction 208 describes “what is happening” and the encoder 108 is tasked with determining the action 210. Continuing the example above, an implicit instruction 208 specifies the operation temperature is too high. The action 210 is then generated at the encoder 108 to address this, e.g., to switch codecs, reduce audio resolution, and so forth. As such, the implicit instruction 208 guides operation of the encoder 108 in selection of the actions 210, indirectly, and thus control is shared by the decoder 110 and the encoder 108. Sensors 124, adaptation instructions 122, and actions 210 are configurable in a variety of ways to address different operational conditions, examples of which are described as follows.

FIG. 3 depicts a non-limiting example 300 in which a sensor 124 of the consumer 104 is a memory sensor 302 that detects an operational condition involving memory 304. The decoder 110 then generates an adaptation instruction 122 to restrict reference frames 306 for communication to the encoder 108 of the producer 102. The sensor 124 as previously described is configurable as a dedicated hardware sensor, implemented using software executed by a processor (e.g., controller), and so forth.

The sensor 124, for instance, accesses an application programming interface (API) and from this detects that an amount of available space in the memory 304 is below a threshold amount. In response, the adaptation instruction 122 is generated by the decoder 110 to restrict generation of reference frames 306. Reference frames are typically implemented as “full” frames that are used to generate additional frames as part of a digital video. Therefore, restricting reference frames reduces an amount of the memory 304 consumed by communications received from the encoder 108 by the decoder 110. Other examples are also contemplated, e.g., in which the adaptation instruction 122 is an implicit instruction 208 that causes the encoder 108 to select an action 210 to restrict reference frames 306.

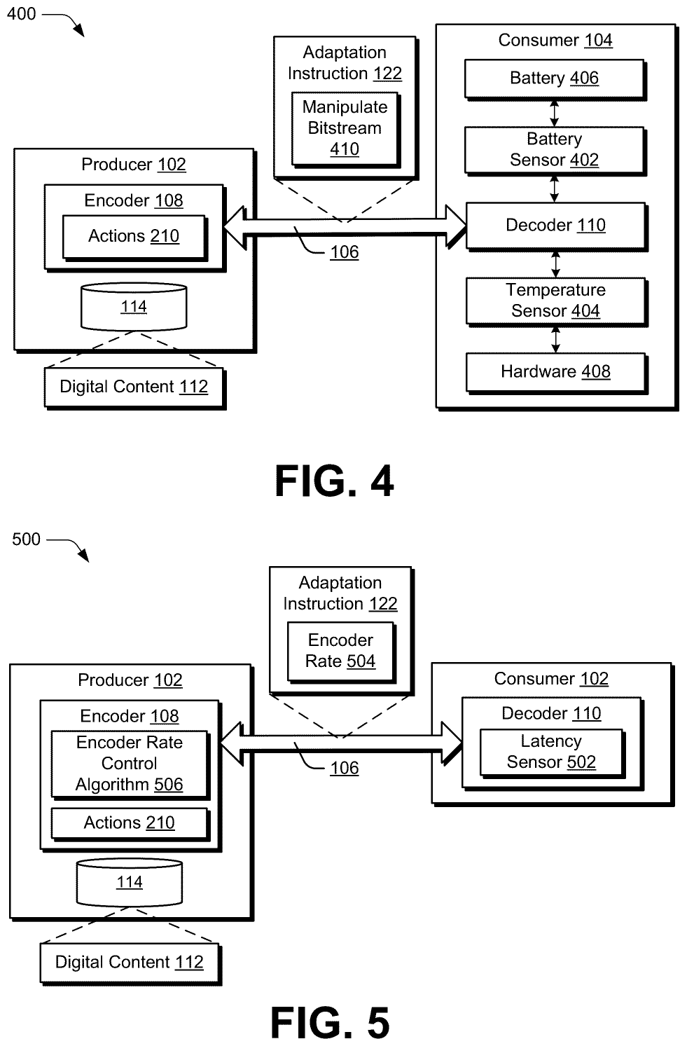

FIG. 4 depicts a non-limiting example 400 in which a sensor 124 of the consumer 104 is a battery sensor 402 or temperature sensor 404 that detects an operational condition. In response, the decoder 110 generates an adaptation instruction 122 to manipulate a bitstream 410 for communication to the encoder 108 of the producer 102. The temperature sensor 404, for instance, is configured to detect a temperature of hardware 408 of the consumer 104. Responsive to detection that the temperature is thermally unsustainable (e.g., for continued operation of the decoder 110 and/or the consumer 104 as a whole), the decoder 110 generates the adaptation instruction 122 to manipulate a bitstream 410.

Likewise, the battery sensor 402 is configured to detect an amount of power that is available form a battery 406. Responsive to detection that the amount of power is below a threshold, the decoder 110 also generates the adaption instruction 122 to manipulate the bitstream 410. This is performed in both examples to minimize power consumption, and therefore an amount of heat generated by the decoder 110 and/or the 104.

The adaptation instruction 122 to manipulate the bitstream 410, for instance, is configured to cause the encoder 108 to perform actions 210 to generate communications that take a reduced number of processing cycles to decode, e.g., as a single slice, to disable modes, disable deblocking filters, and so on. In another instance, the encoder 108 performs actions 210 to manipulate the bitstream such that decoding of the communication has a reduced likelihood of involving “critical” paths, and hence the decoder 110 is provided with additional room in order to overscale and save power.

FIG. 5 depicts a non-limiting example 500 in which a sensor 124 of the consumer 104 is incorporated as part of the decoder 110 to detect an operational condition involving latency. The decoder 110 then generates an adaptation instruction 122 to manipulate an encoder rate 504 for communication to the encoder 108 of the producer 102. In this example, a latency sensor 502 is incorporated as part of the decoder 110 that is configured to detect latency in communications received by the decoder 110. Based on this, the adaptation instruction 122 is configured to specify an increase or decrease in an encoder rate 504 as appropriate. In instances of low latency, for instance, the encoder rate 504 is increased by an encoder rate control algorithm 506 of the encoder 108 responsive to the adaptation instruction 122. In instances of high latency, the encoder rate 504 is decreased by the encoder rate control algorithm 506 of the encoder 108 responsive to the adaptation instruction 122.

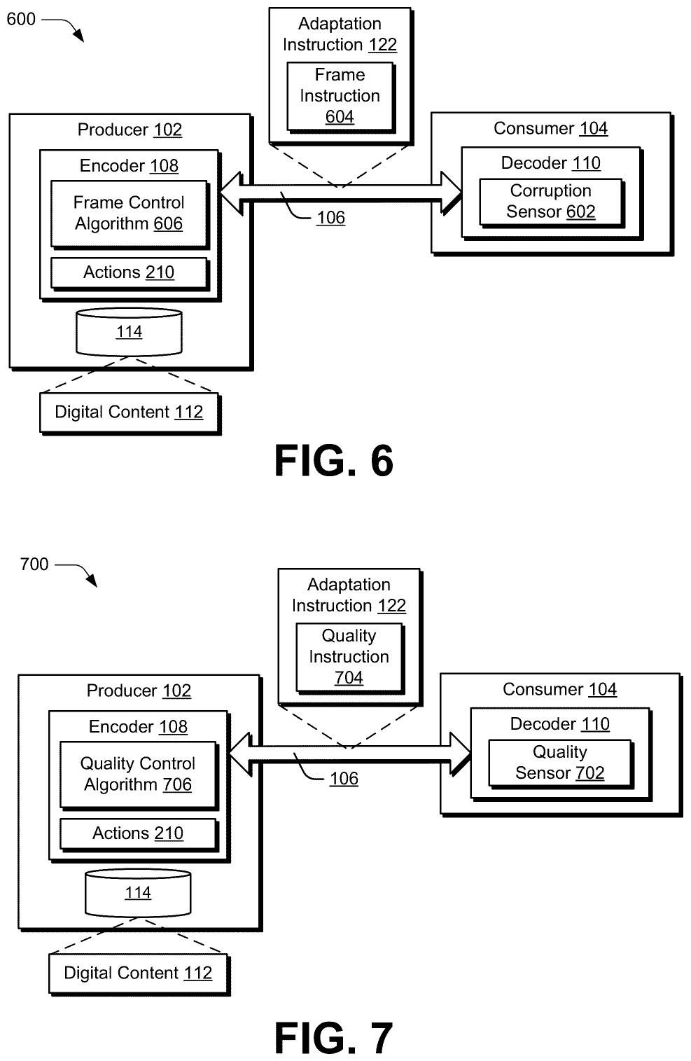

FIG. 6 depicts a non-limiting example 600 in which a sensor 124 of the consumer 104 is incorporated as part of the decoder 110 and detects an operational condition of the decoder 110 involving corruption. In response, the decoder 110 generates an adaptation instruction 122 including a frame instruction 604 for communication to the encoder 108 of the producer 102. The frame instruction 604, for instance, is configured to cause a frame control algorithm 606 of the encoder 108 to respond to and correct the corruption. Examples of this include instructions to invalidate frames from being referenced, forcing an instantaneous decoding refresh (IDR) frame, and so forth. An IDR frame, for instance, is a special type of I-frame that indicates that no frame received after the IDR frame is to reference any frame before it. Therefore, an adaptation instruction 122 configured to “force” an IDR frame is used to correct dependencies of later frames in a digital video on frames that are earlier that the IDR frame in that sequence.

FIG. 7 depicts a non-limiting example 700 in which a sensor 124 of the consumer 104 is incorporated as part of the decoder 110 and detects an operational condition of the decoder 110 involving quality. The decoder 110 generates an adaptation instruction 122 involving quality for communication to the encoder 108 of the producer 102. The sensor 124, for instance, is configured as a quality sensor 702 that is configured to detect quality of frames decoded by the decoder 110, e.g., noise, jitter, interference, and so forth. Accordingly, the quality instruction 704 is configured to cause the encoder 108 to respond to and correct the quality.

Based on this, the quality instruction 704 is configured to specify an increase or decrease in quality as appropriate. In instances of low quality, for instance, the adaptation instruction 122 causes a quality control algorithm 706 of the encoder 108 to increase quality and vice versa in instances of high quality that have an effect on other operational conditions, e.g., thermal, battery, and so forth as described above.

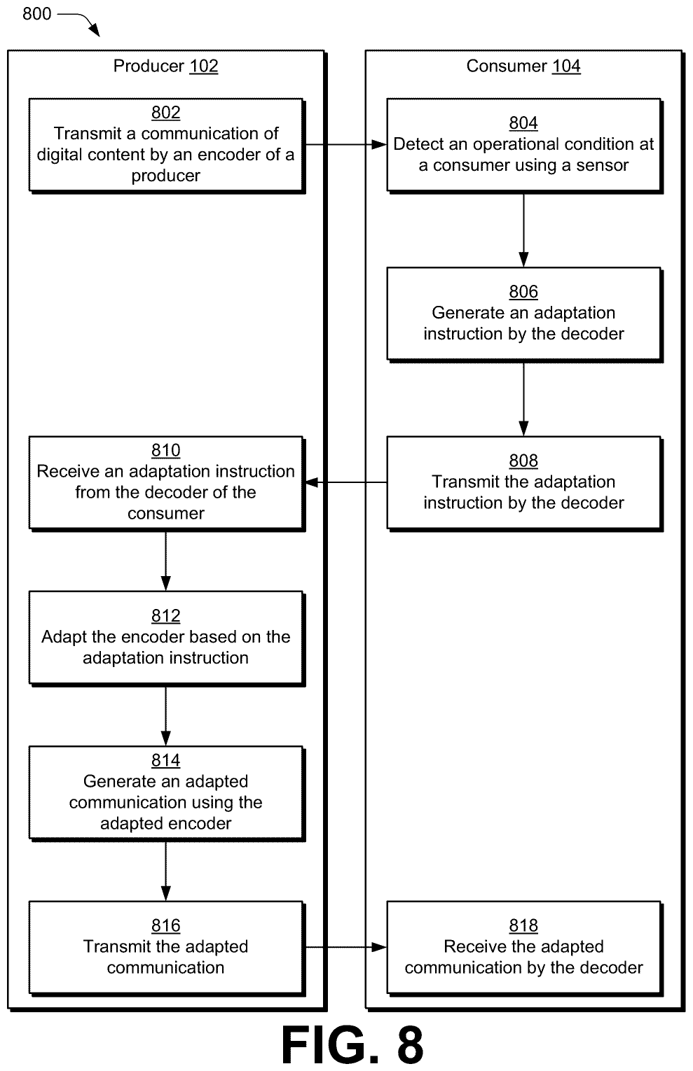

FIG. 8 depicts a procedure 800 in an example implementation of adaptive decoder-driven encoder reconfiguration.

A communication of digital content is transmitted by an encoder of a producer (block 802). By way of example, a communication 116 is transmitted by the encoder 108 over a transmission channel 118 of a communication link 106 to a decoder 110 of a consumer 104.

An operation condition is detected at a consumer using a sensor (block 804). By way of example, a sensor 124 is configured to detect the operational condition. Examples of sensors 124 include a memory sensor 302 of FIG. 3, a battery sensor 402 and temperature sensor 404 of FIG. 4, a latency sensor 502 of FIG. 5, a corruption sensor 602 of FIG. 7, and a quality sensor 702 of FIG. 7. Operation conditions include conditions that affect operation of hardware of the consumer 104, the decoder 110, involve receipt of communications 116 from the encoder 108, and so forth.

An adaptation instruction is generated by the decoder (block 806). By way of example, adaption instructions 122 includes explicit instructions 206 and/or? implicit instructions 208. Explicit instructions 206 are configured to give direct control of actions 210 performed by the encoder 108 to the decoder 110. Implicit instructions 208, on the other hand, are configured to cause the encoder 108 to choose the actions 210 based on the operational conditions described as part of the implicit instruction 208.

The adaptation instruction is transmitted by the decoder (block 808) and is received from the decoder of the consumer (block 810). By way of example, the adaptation instruction 122 is communicated via the communication link 106 from the decoder 110 to the encoder 108.

The encoder is adapted based on the adaptation instruction (block 812). By way of example, the encoder 108 performs actions that configure encoding, encryption, compression, and/or digital rights management based on the adaptation instruction 122.

An adapted communication is generated using the adapted encoder (block 814). By way of example, a subsequent communication 116 is generated by the encoder 108 as reconfigured based on the adaptation instruction 122. The adapted communication is the transmitted (block 816) and received by the decoder (block 818). By way of example, adapted communication is transmitted by the encoder 108 and received by the decoder 110. The decoder 110 then processes the communication 116, for rendering and output by a display device, speakers, for storage in a storage device, and so forth.

It should be understood that many variations are possible based on the disclosure herein. Although features and elements are described above in particular combinations, each feature or element is usable alone without the other features and elements or in various combinations with or without other features and elements.

The various functional units illustrated in the figures and/or described herein (including, where appropriate, the producer 102 and consumer 104) are implemented in any of a variety of different manners such as hardware circuitry, software or firmware executing on a programmable processor, or any combination of two or more of hardware, software, and firmware. The methods provided are implemented in any of a variety of devices, such as a general purpose computer, a processor, or a processor core. Suitable processors include, by way of example, a general purpose processor, a special purpose processor, a conventional processor, a digital signal processor (DSP), a graphics processing unit (GPU), a parallel accelerated processor, a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

In one or more implementations, the methods and procedures provided herein are implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

### CONCLUSION

Although the systems and techniques have been described in language specific to structural features and/or methodological acts, it is to be understood that the systems and techniques defined in the appended claims are not necessarily limited to the specific features or acts described. Rather, the specific features and acts are disclosed as example forms of implementing the claimed subject matter.

1. A method comprising:
generating, by a decoder of a consumer, an adaptation instruction in response to detecting an operational condition of latency associated with a communication of digital content received by the consumer from an encoder of a producer;
transmitting, by the decoder, the adaptation instruction for receipt by the encoder; and
receiving an adapted communication of the digital content generated by the encoder, the adapted communication caused by reconfiguration of the encoder via the encoder executing an encoder rate control algorithm to manipulate an encoder rate based on the adaptation instruction received from the decoder.

2. The method of claim 1, wherein the adaptation instruction is implicit and configured to cause the encoder to determine to execute the encoder rate control algorithm to manipulate the encoder rate be for the reconfiguration of the encoder based on the operational condition described by the adaptation instruction.

3. The method of claim 1, wherein the adaptation instruction is explicit and instructs the encoder to execute the encoder rate control algorithm to manipulate the encoder rate for the reconfiguration of the encoder.

4-9. (canceled)

10. A device comprising:
an interface; and
hardware circuitry connected to the interface, wherein the hardware circuitry is configured to:
generate an adaptation instruction in response to detecting an operational condition of latency associated with a communication of digital content received from an encoder via the interface;
transmit, via the interface, the adaptation instruction for receipt by the encoder; and
receive, via the interface, an adapted communication of the digital content generated by the encoder, the adapted communication caused by reconfiguration of the encoder via the encoder executing an encoder rate control algorithm to manipulate an encoder rate based on the adaptation instruction.

11. The device of claim 10, wherein the adaptation instruction is implicit and configured to cause the encoder to determine to execute the encoder rate control algorithm to manipulate the encoder rate for the reconfiguration of the encoder based on the operational condition described by the adaptation instruction.

12. The device of claim 10, wherein the adaptation instruction is explicit and instructs the encoder to execute the encoder rate control algorithm to manipulate the encoder rate for the reconfiguration of the encoder.

13-16. (canceled)

17. A method comprising:
transmitting a communication of digital content by an encoder of a producer for receipt by a decoder of a consumer;
receiving an adaptation instruction from the decoder of the consumer, the adaptation instruction generated by the decoder in response to detecting an operational condition of latency detected at the consumer using a sensor;
adapting the encoder based on the adaptation instruction by executing an encoder rate control algorithm to manipulate an encoder rate;
generating an adapted communication using the adapted-encoder adapted based on the adaptation instruction; and
transmitting the adapted communication for receipt by the decoder of the consumer.

18. The method of claim 17, wherein the adaptation instruction is implicit and describes the operational condition, and further comprising determining to execute the encoder rate control algorithm to manipulate the encoder rate for adapting the encoder based on the adaptation instruction.

19. The method of claim 17, wherein the adaptation instruction is explicit and instructs the encoder to execute the encoder rate control algorithm to manipulate the encoder rate for adapting the encoder.

20. (canceled)

21. The method of claim 2, wherein the operational condition of latency comprises the operational condition of low latency, and the encoder executes the encoder rate control algorithm to increase the encoder rate.

22. The method of claim 2, wherein the operational condition of latency comprises the operational condition of high latency, and the encoder executes the encoder rate control algorithm to decrease the encoder rate.

23. The method of claim 3, wherein the operational condition of latency comprises the operational condition of low latency, and the encoder executes the encoder rate control algorithm to increase the encoder rate.

24. The method of claim 3, wherein the operational condition of latency comprises the operational condition of high latency, and the encoder executes the encoder rate control algorithm to decrease the encoder rate.

25. The method of claim 1, wherein generating, by the decoder of the consumer, the adaptation instruction in response to detecting the operational condition of latency comprises generating, by the decoder of the consumer, the adaptation instruction in response to detecting, by a latency sensor of the decoder of the consumer, the operational condition of latency.

26. The device of claim 11, wherein the operational condition of latency comprises the operational condition of low latency or the operational condition of high latency, and the encoder executes the encoder rate control algorithm to increase the encoder rate or decrease the encoder rate, respectively.

27. The device of claim 12, wherein the operational condition of latency comprises the operational condition of low latency or the operational condition of high latency, and the encoder executes the encoder rate control algorithm to increase the encoder rate or decrease the encoder rate, respectively.

28. The device of claim 10, wherein the hardware circuitry is one or more of a decoder circuit, a processor, a controller, a field programmable gate array, and an integrated circuit.

29. The method of claim 18, wherein the operational condition of latency comprises the operational condition of low latency or the operational condition of high latency, and the encoder executes the encoder rate control algorithm to increase the encoder rate or decrease the encoder rate, respectively.

30. The method of claim 19, wherein the operational condition of latency comprises the operational condition of low latency or the operational condition of high latency, and the encoder executes the encoder rate control algorithm to increase the encoder rate or decrease the encoder rate, respectively.

31. The method of claim 17, wherein the sensor comprises a latency sensor and the decoder comprises the latency sensor.
